(19) United States
(12) Patent Application Publication
(10) Pub. No.: US 2026/0242044 A1
(43) Pub. Date: Aug. 20, 2026

(54) PARASAIL OPENING AND CLOSING SYSTEM

(71) Applicant: Ioannis XOMERITAKIS, Chania (GR)

(72) Inventor: Ioannis XOMERITAKIS, Chania (GR)

(21) Appl. No.: 19/471,907

(22) PCT Filed: Apr. 2, 2024
(86) PCT No.: PCT/GR2024/000010

§ 371 Date: Oct. 2, 2025

(30) Foreign Application Priority Data
Apr. 5, 2023 (GR) 20230100292

(51) Int. Cl. B63H 9/072; B63H 9/10; B64D 17/62

(52) U.S. Cl. CPC B63H 9/072; B63H 9/10; B64D 17/62

(57) ABSTRACT

The invention relates to a system for opening and closing a parachute (3), which allows easy and safe opening and closing. The system has a central pillar (1) with a transit ring (2) through which the pulling rope (10) of the opening and closing winch (9) of the parachute, which is located in the bow of the vessel (4), passes. At the same tune, the opening and closing winch (9) of the parachute also uses the existing system of the flight winch (11). For the operation of the winches (9), (11) a double control (13) is used with two levers (14), one for each winch and a common oil supply from an oil tank (15), via a high-pressure pump (16), which is driven by the boat engine (17). With this system the vessel (4) operator can raise or lower and retract the parachute (3) without, any problems.

### THE FIELD OF THE ART

The invention relates to the field of transport and in particular to the field of ships or other waterborne vessels and their associated equipment. In particular, it relates to the field of vessels specially adapted for water sports or recreation activities. It further refers to body support devices specially adapted for water sports or recreation. In addition, it refers to the field of equipment installed on board vessels and in particular refers to parachutes. In particular, it refers to a system for opening and closing a sea parachute.

### BACKGROUND OF THE INVENTION

The parasail opening and closing system disclosed herein has never been publicly disclosed before and has not been disclosed in the state of the art known to date.

Parasailing is a recreational activity where a person hovers behind a boat while attached to a specially designed parachute. Thus, as the pilot of the boat takes over all handling of both the boat and the parachute, the person suspended from the parachute can enjoy the view of the area from above. Although it is a highly enjoyable leisure activity, to date the process of opening and closing the parasail has been very laborious for the boat operators, it is complex, requires at least two people and generally causes a feeling of insecurity among customers due to its difficulty.

These parasails usually have a large diameter, as they are often required to lift more than one person. As a result of their size, when they are closed, their sail forms a straight line with a very long length, in relation to the available space on board. This increases the likelihood that when they are closed, all or even part of them will fall into the water and get wet. Especially considering that closing requires the parachute to be very low in height, it becomes practically impossible to close it without getting wet. As a consequence, its weight increases significantly, making it practically unusable, at least until it dries out, while it also wears out and thus reduces its life and use. Moreover, due to wear and tear, its safety is reduced and it loses its flight stability. At the same time, the opening and closing procedures are highly technical, requiring a high level of expertise, both from the operator of the vessel and his assistant, and must be carried out with great speed, generally causing stress and giving an unpleasant feeling to the customer. And given that most of them are opened manually, it is not uncommon for operators to suffer injuries, especially to their hands. Generally speaking, the experience of the customer, while it may be very pleasant when floating in the air, usually ends up with failures during opening and closing, especially from the moment of landing on board until the closing of the parachute.

For all of the above reasons, parasail owners are forced to use smaller parasails to make them easier to open and close, resulting in a higher speed required for flight. This results in higher fuel consumption, damage to the engine and boat and increased risk to the customers riding with the parasail, due to the marginal lift conditions. In addition, it is very difficult to train pilots and pilot assistants.

It is thus an object of the present invention to advantageously address the aforementioned disadvantages and shortcomings of the prior art by proposing a system for opening and closing a parasail.

It is a further objective of the present invention to provide a system for opening and closing a parasail, which ensures that it will not get wet and will retract smoothly regardless of its size, thereby increasing the level of protection of the equipment and allowing the use of even very large parachutes.

It is a further objective of the present invention to provide a system for opening and closing a parasail, which due to its construction and the parts that make it up, does not require any particular specialization or skill on the part of the boat operator and his assistant. In addition, due to the construction it is ensured that even a single person can, in parallel with the operation of the boat, achieve the opening and closing of the parachute.

An additional advantage of the invention is that due to the safety provided by the existence of the parasail opening and closing system, all procedures are carried out at a more relaxed pace, at a slower speed, thus imparting a feeling of safety to the customers of the boat. At the same time, it is very easy to train personnel in its use.

These and other objects, features and advantages of the invention will become apparent in the following detailed description.

### BRIEF DESCRIPTION OF THE DRAWINGS

The invention will be made apparent to those skilled in the art by reference to the accompanying figures, in which it is illustrated in an illustrative non-limiting manner.

FIG. 1 shows in top view an illustrative depiction of a vessel with the elements used by the system of the invention for opening and closing the parasail.

FIG. 2 shows in an illustrative perspective view a cross-sectional view of a vessel together with the parasail at a moment when the marine parachute is fully deployed.

FIG. 3 shows an illustrative perspective view of a cross-section of a vessel with the parasail at a moment when it has started to deploy.

FIG. 4 shows an illustrative perspective view of a sectional view of a vessel with the parasail at a moment when it is in the process of closing.

FIG. 5 shows an illustrative perspective view of a sectional view of the vessel with the parasail at a moment when it is fully closed and can be retracted by the operator.

### DETAILED DESCRIPTION OF A PREFERRED EMBODIMENT

Referring now to the accompanying figures, we will describe by means of an illustrative application the parasail system, in order to make its mode of operation and its particular technical characteristics apparent.

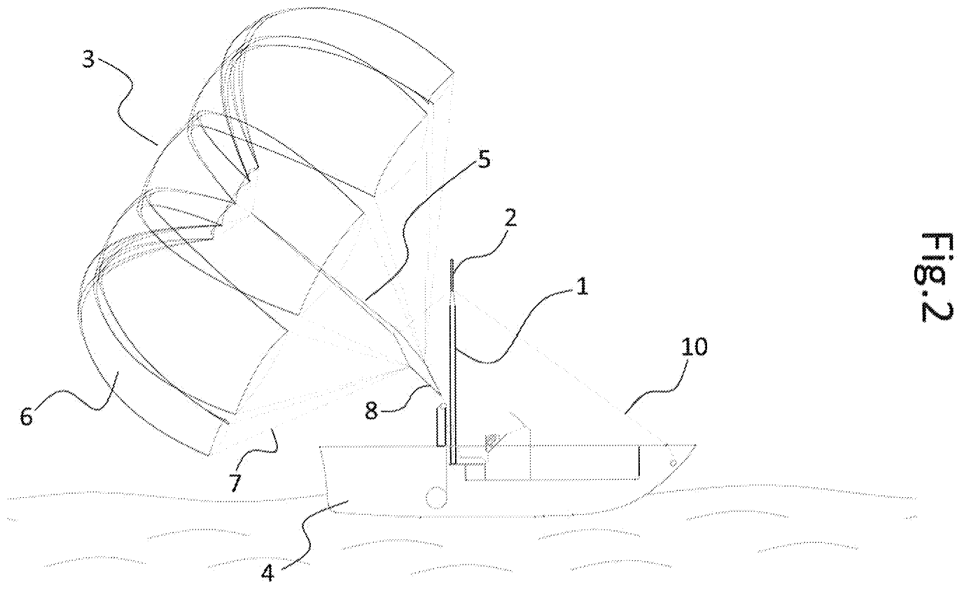

The parasail opening and closing system of the invention comprises a central pillar (1), FIG. 2, which at its upper part ends in a transit ring (2) for the parachute (3). The central pillar (1) may be directly attached to the vessel (4) or may be mounted on a roll bar which may be fitted to the vessel (4). Each parachute (3) shall consist of at least two central canopy lines (5), a canopy (6) and at least 16 canopy lines (7), which shall hold the canopy (6) circumferentially, giving it the familiar shape that parachutes have when they are open, due to the traction they exert on it, and are attached to a traction belt (8), where all the lines (5), (7) of the parachute (3) are gathered.

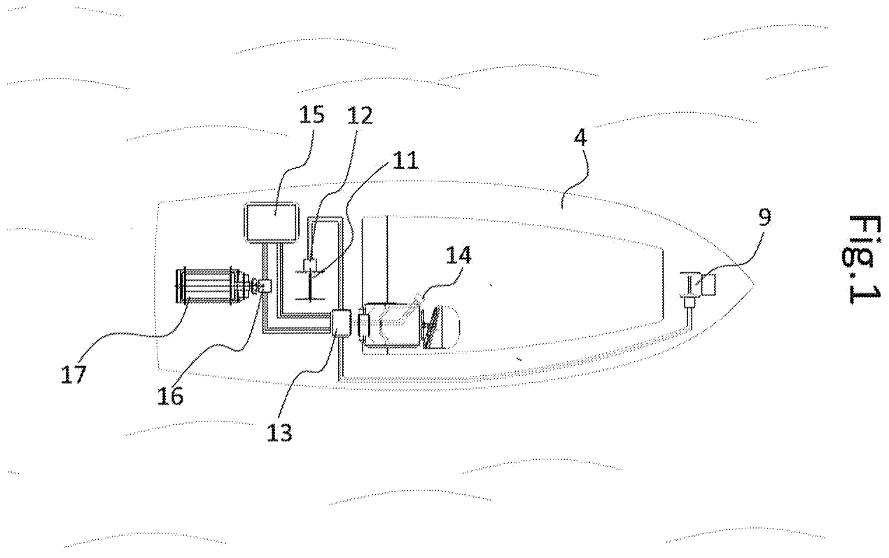

The system of the invention has a winch (9) for opening and closing the parachute, preferably hydraulic, with a hydraulic motor, FIG. 1, which is installed forward, either on the hull of the vessel or on its deck. The opening and closing winch (9) of the parachute shall have a roller, preferably V-shaped, to guide its pulling rope (10). At the same time, the system of the invention uses the already existing system of the flight winch (11), which is provided on the vessel (4) and which is controlled by a hydraulic motor (12) for the flight winch (11). To control each of the two winches (9), (11) the system of the invention has a double control (13) and two levers (14), one for each winch (9), (11). The double control (13) is operated by high pressure oil, which is fed from an oil tank (15), via a high-pressure pump (16), which is driven by the engine of the vessel (17).

If the winches (9), (11) are not in operation, the oil circulates in the system and returns to the oil tank (15). However, if either the parachute opening and closing winch (9) or the flight winch (11) is in operation, then the oil is fed via the double control (13) to the corresponding hydraulic motor, which is turned clockwise or counterclockwise. The direction of rotation of each hydraulic motor depends on whether it extends or retracts the respective winch. It should be noted that although the simultaneous use of the winches (9), (11) is possible, albeit with a lower efficiency for each winch, this is practically not required, since the opening or closing of the parachute (3) always precedes or follows, respectively, the flight of the latter.

In an illustrative example concerning the operation of the parachute opening and closing system according to the present invention, initially the parachute (3) and in particular its canopy (6) is loosely laid out at the rear of the vessel (4), connected to the pulling rope (10) of the parachute opening and closing winch (9), ready for flight. The pulling rope (10) of the opening and closing winch (9) is connected to both the central canopy lines (5) and the canopy lines (7), while passing through it, as well as the central canopy lines (5) and the canopy lines (7) through the transit ring (2), with the result that the canopy (6) is suspended high above the central pillar (1) and slightly below the transit ring (2). The operator of the vessel (4), by controlling with the lever (14) of the double control (13) the opening and closing winch (9) of the parachute, provides a pulling rope (10) and thus the canopy (6) of the parachute (3) fills with air and starts to deploy aft of the vessel (4). When the parachute (3) is fully deployed in diameter, both the central canopy lines (5) and the canopy lines (7) of the parachute (3) are released from the opening and closing winch (9), releasing it and allowing the flight winch (11) to take control to initiate flight.

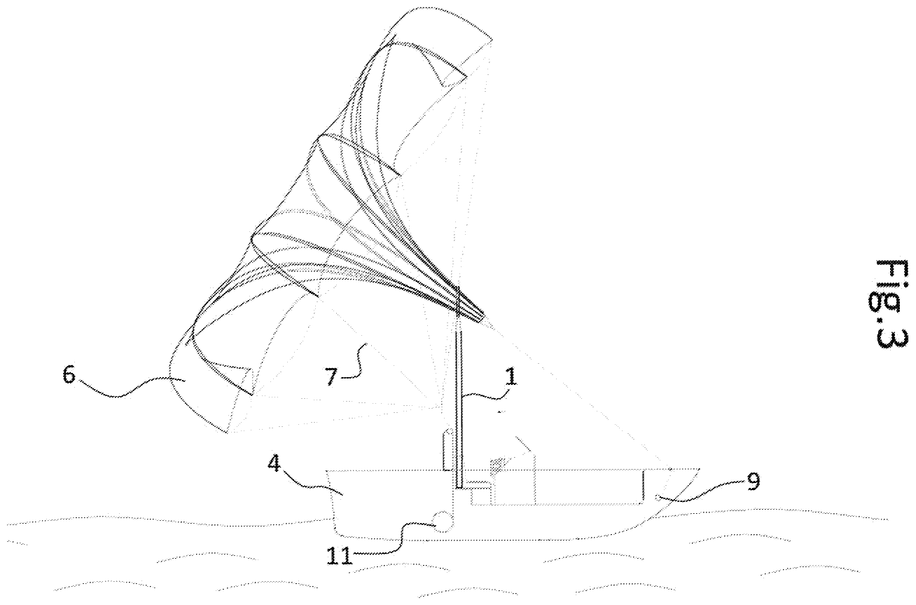

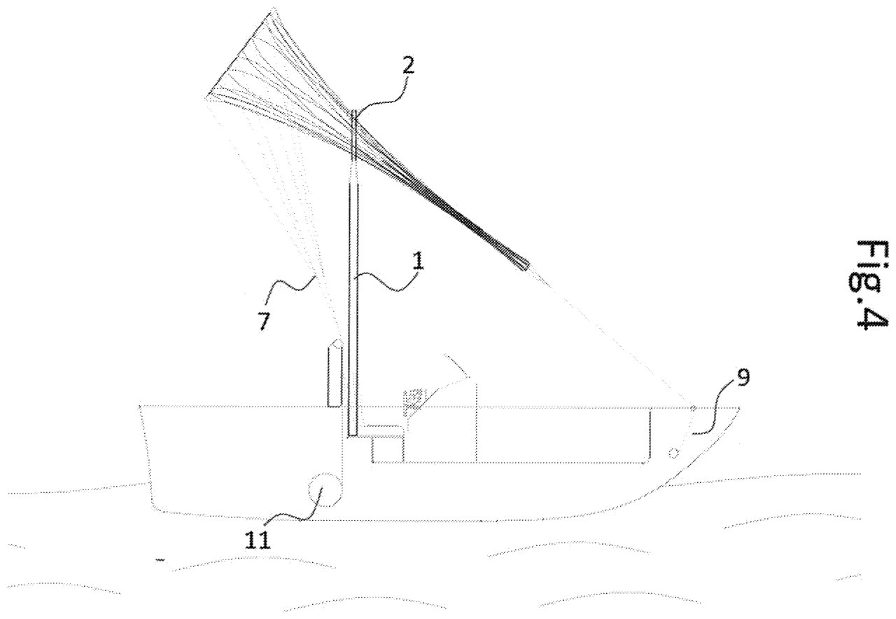

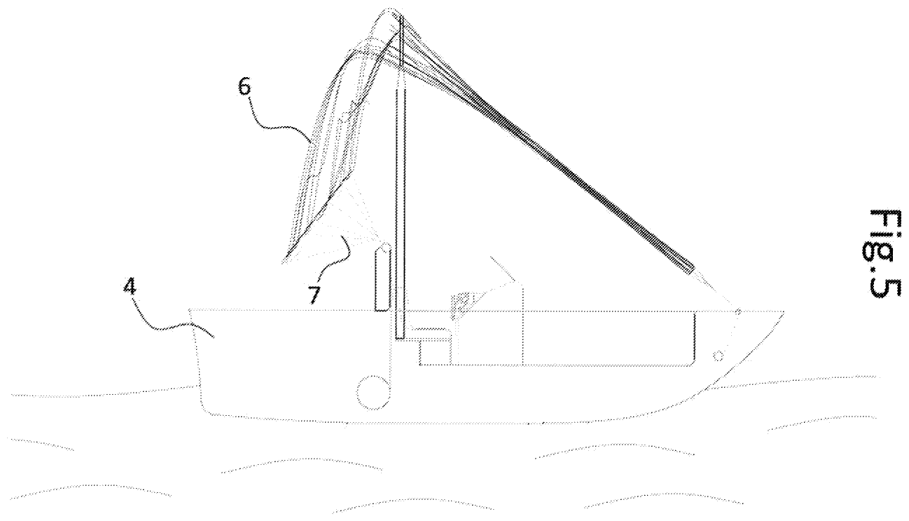

Similarly, during the process of closing the parachute (3) and while the canopy (6) is fully deployed, the operator shall connect the central ropes of the canopy (5) to the pulling rope (10) of the parachute opening and closing winch (9), after having first activated the flight winch (11) and having retracted the hauling strap (8), the canopy main lines (5) and the canopy lines (7) to its base, FIG. 3. Activation of the parachute opening and closing winch (9) drives the parachute centres (3) and part of the canopy (6) through the passage ring (2) of the central pillar (1), FIG. 4, picking up the canopy (6) and letting it fall loosely from the central pillar (1) to the rear of the vessel (4), FIG. 5.

In an alternative embodiment of the invention, the parachute opening and closing winch (9) may be electric and may be powered by the boat battery (4) or even by an additional battery. It may use a switch for its operation.

It should be noted at this point that the description of the invention has been given with reference to illustrative examples of application, to which it is not limited. Therefore, any alteration or modification with regard to the shape, dimensions, morphology of the components of the system construction, as long as they do not constitute a new inventive step and do not contribute to the technical development of what is already known, are considered to be within the aims and objectives of the present invention.

1. A parasail opening and closing system, comprising:
a central pillar (1) with a transit ring (2) in its upper part, with a flight winch (11) attached to a hauling strap (8), on which at least two central canopy lines (5) and canopy lines (7) holding a peripheral canopy (6) of a parachute (3) are assembled, a parachute opening and closing winch (9) installed in the bow of the vessel (4), a double control (13) with two levers (14), one for controlling the parachute opening and closing winch (9) and one for controlling the flight winch (11), which is operated by high pressure oil, fed from an oil tank (15), via a high pressure pump (16), driven by the engine (17) of the vessel (4), wherein the opening and closing winch (9) of the parachute (3) guides the at least two central canopy lines (5) and the canopy lines (7) of the parachute (3), during opening, and the at least two central canopy lines (5) and part of the canopy (6) during closing, through the transit ring (2).

2. The parasail opening and closing system according to claim 1, wherein the central pillar (I) is directly attached to the vessel

3. The parasail opening and closing system according to claim 1, wherein the central pillar (1) is installed on a roll bar of the vessel

4. The parasail opening and closing system according to claim 1, wherein the parachute opening and closing winch (9) is electric and powered by the battery of the vessel (4).

5. The parasail opening and closing system according to claim 1, wherein the parachute opening and closing winch (9) is powered by an additional battery.
